(19) United States
(12) Patent Application Publication
(10) Pub. No.: US 2006/0111835 A1
(43) Pub. Date: May 25, 2006

(54) Location system for locating a parked vehicle, a method for providing a location of a parked vehicle and a personal wireless device incorporating the system or method

(75) Inventors: Richard M. Baker, Dallas, TX (US); Leonardo W. Estevez, Rowlett, TX (US); Carl Panasik, Garland, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/997,412

(22) Filed: Nov. 23, 2004

(51) Int. Cl. G01C 21/26

(52) U.S. Cl. 701/207; 701/1; 340/988

(57) ABSTRACT

A location system for locating a parked vehicle, a method for providing a location of a parked vehicle and a personal wireless device including the location system or method. In one embodiment, the personal wireless device includes (1) a positioning system, (2) a user interface and (3) a parked vehicle location system coupled to the positioning system and the user interface. The parked vehicle location system includes (3A) a parking determiner configured to automatically ascertain and store at least one parking event of a vehicle associated with the personal wireless device and (3B) a parking event retriever, coupled to the parking determiner, configured to present the at least one stored parking event.

### TECHNICAL FIELD OF THE INVENTION

The present invention is directed, in general, to a system or method for locating parked vehicles and, more specifically, to a personal wireless device incorporating the system or method.

### BACKGROUND OF THE INVENTION

Drivers often forget where they have parked their vehicle. This is especially true when the drivers are in a hurry. Drivers may be running late to watch a sporting event, catch a movie or catch an airplane and quickly pull into a parking spot without thinking about the parking location. In addition to being in a hurry, the size of a parking lot and the similarities of a parking garage contribute to forgetting the location of the parking spot.

When a driver cannot remember where a vehicle was parked, there are limited options to assist in locating the vehicle. Some drivers may be able to acquire help from a security guard or a Good Samaritan to drive around a parking area and look for the lost vehicle. If even possible, this is often frustrating, embarrassing and time consuming. Other drivers may be able to use a remote lock/unlock control to activate the horn or lights of the vehicle to assist in finding the parking location. Unfortunately, drivers must be proximate to the vehicles for the remote to work.

To prevent losing a vehicle, some drivers may input into a positioning system device where the vehicle is parked. For example, a driver could enter waypoints into a global positioning system (GPS) receiver. This, however, requires the drivers to physically interact with the GPS receiver to store the location. This can be difficult and is often forgotten when in a hurry. Additionally, access to a GPS receiver is required.

Accordingly, what is needed in the art is a system and method that provides the location of parked vehicles without requiring input from the drivers. More specifically, what is needed is a way to locate parked vehicles without requiring a dedicated device in each vehicle or for each driver.

### SUMMARY OF THE INVENTION

To address the above-discussed deficiencies of the prior art, the present invention provides a location system for locating a parked vehicle, a method for providing a location of a parked vehicle and a personal wireless device incorporating the system or method. In one embodiment, the location system includes (1) a parking determiner configured to automatically ascertain and store at least one parking event of the vehicle and (2) a parking event retriever, coupled to the parking determiner, configured to present the at least one stored parking event.

In another embodiment, the present invention provides the method for providing a location of a parked vehicle including (1) automatically ascertaining at least one parking event of the vehicle, (2) automatically storing the at least one parking event and (3) presenting the at least one stored parking event.

In yet another embodiment, the present invention provides the personal wireless device including (1) a positioning system, (2) a user interface and (3) a parked vehicle location system coupled to the positioning system and the user interface. The parked vehicle location system includes (3A) a parking determiner configured to automatically ascertain and store at least one parking event of a vehicle associated with the personal wireless device and (3B) a parking event retriever, coupled to the parking determiner, configured to present the at least one stored parking event.

The present invention, therefore, provides automatically determining and automatically storing parking events without input from a user (i.e., driver or occupant of the vehicle). For the purpose of this invention, vehicles generally apply to various types of transportation machines such as automobiles, bicycles, boats, etc. Additionally, a parking event is recognized at the happening of an event or a series of events that is/are associated with parking a vehicle. Typically, the event or events are pre-identified as associated with parking. An example of these events, are slowing down, turning (changing direction) and stopping. The parking determiner can intelligently monitor these events via the positioning system (i.e., a GPS receiver) and automatically determine that a parking event has occurred.

Thus, the present invention automatically recognizes when vehicles are being parked and automatically stores the location of parked vehicles without requiring the interaction of the user. Accordingly, users do not have to manually enter locations. Additionally, the present invention is not dependent on any additional system or device for the vehicle but can be used in multiple vehicles. Furthermore, the present invention advantageously employs existing positioning systems in such personal wireless devices as cellular telephones.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the invention, reference is now made to the following descriptions taken in conjunction with the accompanying drawing, in which:

FIG. 1 illustrates a block diagram of an embodiment of a personal wireless device constructed according to the principles of the present invention; and

FIG. 2 illustrates a flow diagram of an embodiment of a method for providing a location of a parked vehicle carried out according to the principles of the present invention.

### DETAILED DESCRIPTION

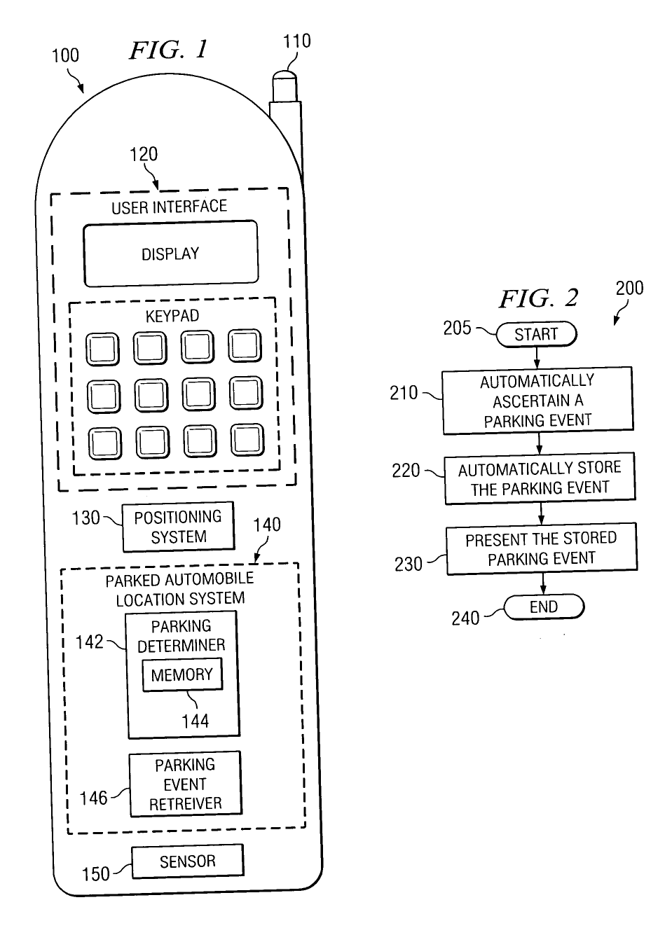

Referring initially to FIG. 1, illustrated is a block diagram of an embodiment of a personal wireless device (PWD), generally designated 100, constructed according to the principles of the present invention. The PWD 100 includes an antenna 110, a user interface 120, a positioning system 130 and a parked vehicle location system 140 and a sensor 150. The parked vehicle location system 140 includes a parking determiner 142 and a parking event retriever 146.

The PWD 100 is a cellular telephone that has locating or navigating capability (i.e., positioning system 130). In other embodiments the PWD 100 may be another electronic device having locating or navigating capability, such as, a personal digital assistant (PDA), an MP3 player, a laptop computer or a combination thereof. The PWD 100 is also Bluetooth enabled. Of course, in other embodiments, the PWD 100 may not be Bluetooth enabled. Additionally, one skilled in the art will understand that the PWD 100 includes other components and systems typically employed within a conventional cellular telephone that are not illustrated or discussed.

The antenna 110, the user interface 120 and the positioning system 130 are conventional components or systems typically employed within a cellular telephone. The user interface 120 includes a display and a keypad that are configured to allow a user to interact with the PWD 100. The user interface 120 may also include a microphone and a speaker for interaction (not illustrated).

The positioning system 130 may be a GPS receiver. Of course in other embodiments, the PWD 100 may employ other locating or navigating systems. The positioning system 130 is configured to provide information about the PWD 100, such as, location or motion information. For example, the positioning system 130 can be employed to determine the velocity, the acceleration, the location, the direction, etc. of the PWD 100. The location or motion information may be entered into the positioning system 130 as a journal entry. One skilled in the art will understand the operation and configuration of the positioning system 130.

The parked vehicle location system 140 is configured to provide a location of a parked vehicle. Typically, the parked vehicle location system 140 employs the positioning system 130 to provide the location. The parked vehicle location system 140 may be implemented as a series of operating instructions, as dedicated hardware or a combination thereof. The parked vehicle location system 140 may be wholly implemented within the PWD 100 or have at least a portion located externally, such as, within a central monitoring station of a cellular telephone system. Thus, in some embodiments, a portion of the parked vehicle location system 140 could be employed by multiple PWDs.

Portions of the parked vehicle location system 140 may also be located in the vehicle. For example, the parking determiner 142 could be located in the vehicle and determine a parking event based on when the ignition is turned-off. This information could then be transferred to the PWD 100 to be employed by the parking event retriever 146.

The parking determiner 142 is configured to automatically ascertain and store parking events of a vehicle associated with a user of the PWD 100. The parking determiner 142 may store some or all of the parking events in a database. The database may be located in a dedicated memory 144. The memory 144 may be a conventional memory configured expressly for storing the parking events. In other embodiments, the parking determiner 142 may store the parking events in a portion of a memory of the PWD 100 that is employed by multiple systems of the PWD 100. Additionally, the database of the parking events, or at least portions thereof, may be stored external to the PWD 100 and retrieved when needed. Accordingly, the PWD 100 may be employed to ascertain and store the parking events while another PWD retrieves the stored parking events when needed. For example, a person may leave a vehicle for a person at a location (airport) for an other person to use (an incoming passenger). The incoming passenger can then retrieve the stored parking events to determine the location of the vehicle.

In some embodiments, the parking determiner 142 is configured to automatically ascertain the parking events based on entries into the positioning system 130. The parking determiner 142 may communicate with the positioning system 130 to periodically determine when changes occur in the velocity, direction, acceleration, etc., of the PWD 100. From changes in these motion attributes, the parking determiner 142 may ascertain a parking event of a vehicle associated with the PWD 100.

For example, the parking determiner 142 may determine from the entries of the positioning system 130, that the PWD 100 is traveling at a velocity greater than a walking speed (approximately less than three miles per hour) and conclude that the PWD 100 is traveling in a vehicle. From additional entries, the parking determiner 142 may conclude that the PWD 100 is no longer moving and notes the location of the PWD 100 when the PWD 100 stopped. Subsequently, the parking determiner 142 obtains additional entries to determine if the PWD 100 is moving at a velocity of a person walking. If so, the parking determiner 142 may conclude that the user left the vehicle and is now walking with the PWD 100. Accordingly, the parking determiner 142 stores the noted location of the PWD 100 as a parking event. Additionally, the parking determiner 142 may store a time associated with the parking event. Thus, the parking determiner 142 may employ at least one of the location or motion attributes of the PWD 100 entered into the positioning system 130 to determine a parking event.

The parking determiner 142 may also employ the sensor 150 to determine motion attributes of the PWD 100. For example, in one embodiment the sensor 150 may be an accelerometer that the parking determiner 142 employs to detect the gait of a person walking and thus determine that the PWD 100 is no longer in the vehicle. The sensor 150 may be a conventional accelerometer installed in the PWD 100 at the factory. Add-on sensors of the PWD 100 (added after manufacturing) may also be employed by the parking determiner 142 to ascertain parking events.

In another embodiment, the sensor 150 may be a microphone that the parking determiner 142 employs to ascertain a parking event based on audio. The parking determiner 142 may employ the sensor 150 to detect sounds associated with parking a vehicle. For example, the parking determiner 142 may be configured to compare sounds heard through the sensor 150 with known sounds (i.e., a radio being turned off, an engine being turned off, a vehicle door being closed, etc.) associated with parking a vehicle. These known sounds can be saved in the memory 144. When the parking determiner 142 obtains a match, the location of the PWD 100 at that time is stored as a parking event.

Of course, the microphone of the user interface 120 may be employed to capture audio instead of the sensor 150. Regardless, monitoring for sounds associated with parking a vehicle may not be continual. The microphone (or sensor 150) may be activated to start monitoring for applicable audio when other events (a change in motion attributes) suggest a parking event.

In yet another embodiment, the sensor 150 may be a conventional Radio Frequency Identification (RFID) receiver. The PWD 100, therefore, would have the ability to scan RFID tags. Accordingly, RFID tags can be placed in or on the vehicle along with RFID ‘landmark’ tags throughout a parking garage. When the user leaves the vehicle, the PWD 100 can detect that the vehicle RFID tag is no longer present and begins scanning for the landmark RFID tags. The PWD 100 automatically logs the trajectory of the landmark tags to determine the most likely location for the vehicle.

By employing an RFID receiver, the PWD 100 can correlate the scanned RFID tags with a map via a server and network connection to provide a graphical relationship. Alternatively, the PWD 100 may develop a relational map based on the sequence of RFID tags detected. The user can then retrace the trajectory with real-time scanning and feedback of the PWD 100.

The series of trajectory provided by the landmark RFID tags would prove especially useful to allow the user to successfully navigate to a parking area within a multilevel parking garage. For example, the trajectory from the landmark RFID tags can be used when the vehicle is rented in a foreign city and the trajectory from an airport terminal to the vehicle may be sent via to the PWD 100 (i.e., SMS or e-mail) before the arrival of the user.

Additionally, the RFID tags may contain meaningful information regarding location thereof. For example, an RFID tag placed in a parking garage could contain parking area information, 23B, to indicate a parking area surrounding gate 23B at an airport. The RFID tag could also indicate the level in which the vehicle is parked in a multi-level parking area. In this embodiment, the RFID receiver (sensor 150) can receive this information from the RFID tag and store it for subsequent use. Accordingly, subsequent trajectory need not be known because the location, 23B, can be systematically indexed.

The parking determiner can also determine a parking event based on a disconnect signal of the PWD 100. Many vehicles have Bluetooth capability that allows a Bluetooth enabled PWD, such as the PWD 100, to interact with an audiovisual system of the vehicle. When the PWD 100 is proximate a Bluetooth enabled vehicle, the PWD 100 and the Bluetooth system of the vehicle initiate communication. When the PWD 100 is removed from the vehicle (no longer proximate thereto), a disconnect signal is generated by the PWD 100. The parking determiner 142 may store the location of the PWD 100 at the time of the disconnect signal as a parking event.

As discussed, the parking determiner 142 may determine multiple parking events. Each of the multiple parking events that are stored may not be an actual parking event. Though an event or events used to identify a parking event may be pre-determined, the parking determiner 142 may be configured to adaptively determine an event or events that identify a parking event. In one embodiment, the parking determiner 142 may learn by cooperating with the parking event retriever 146. The parking event retriever 146 may list a series of parking events that the user can select or delete. Thus, the parking determiner 142 can use the event or events associated with the deleted and selected parking events to de-emphasize or emphasize, accordingly. The parking determiner 142, therefore, can adaptively ascertain parking events and reduce the number of false parking events that are stored.

In one embodiment, the parking determiner 142 can prompt the user to ask for verification of a parking event. Prompting may be achieved via a beep of the PWD 100. Accordingly, the user can employ the user interface 120 to reply to the prompt and assist the parking determiner 142 in adapting to ascertain parking events.

The parking event retriever 146, coupled to the parking determiner 142, is configured to present parking events of the vehicle. As discussed above, the parking determiner 142 of the PWD 100 ascertains these parking events. In one embodiment, the parking event retriever 146 is configured to present stored parking events employing the user interface 120. The driver may employ the keypad to instruct the parking event retriever 146 to provide a list of various times associated with a parking event. The parking event retriever 146 obtains the times from the memory 144 and presents the times on the display allowing the driver to select one of the times for viewing. The vehicle location associated with the selected time is then presented on the display. The location may be presented as text (i.e., corner of Saint Ledger Drive and Barnett Street) or as a location on a map. Additionally, the present location of the PWD 100 can also be displayed to assist the user in reaching the parked vehicle.

The parking event retriever 146 may also be configured to employ a calendar associated with the PWD 100 to access parking events. The driver may instruct the parking event retriever 146 to present parking events associated with a certain date or with a certain scheduled event. For example, the parking event retriever 146 may access parking events occurring around the approximate time of a trip involving a flight scheduled on the calendar. Thus, a driver can easily access the appropriate parking event when returning to the airport after the trip.

Additionally, as discussed above, the PWD 100 may be configured to send parking events to an other device configured to present the parking events. The antenna 110 may be employed for sending the parking events. The other device may be a different PWD or even a stationary device such as a desktop computer. In one embodiment, the parking events may be sent through text messaging (i.e., corner of Saint Ledger Drive and Barnett Street). Of course, the user would not have to enter the location manually. In other embodiments, the different PWD could access a database where the parking events are stored and download the parking events. In some embodiments, the different PWD could access a voice messaging service (voice mail) to obtain the parking events. In this embodiment, the parking events could be sent as text and then converted to audio via a conventional text-to-speech converter.

Turning now to FIG. 2, illustrated is a flow diagram of an embodiment of a method for providing a location of a parked vehicle, generally designated 200, carried out according to the principles of the present invention. The method 200 begins with an intent to locate a vehicle that has been parked in a step 205.

After beginning, a parking event of the vehicle is automatically ascertained in a step 210. In one embodiment, the parking event may be automatically ascertained based on entries of a positioning system. The entries may represent location or motion attributes of a PWD associated with the vehicle. For example, the entries may provide a direction, an acceleration or a velocity of the PWD. A change in these attributes may be employed to identify a parking event. In some embodiments, the parking event may be automatically ascertained solely based on the entries.

In another embodiment, automatically ascertaining the parking event may be based on sensors of the PWD. For example, a microphone of the PWD may be employed to detect sounds associated with a vehicle being parked. Another sensor may be employed to detect for the absence of vibration that is associated with a running engine of the vehicle. An accelerometer may also be employed to detect that the PWD is no longer moving in the vehicle and indicate that vehicle may have been parked. Additionally, a parking event may be automatically ascertained based on a disconnect signal of the PWD. In some embodiments, automatically ascertaining may be adaptive.

After automatically ascertaining the parking event, the parking event is automatically stored in a step 220. The parking event may be stored in a dedicated memory of the PWD. Additionally, the parking event may be stored in a portion of a general-purpose memory of the PWD. In some embodiments, the parking event may be stored in a memory that is external to the PWD. One skilled in the art will understand that multiple parking events may be stored.

Subsequent to automatically storing the parking event, the stored parking event is presented in a step 230. The stored parking event may be presented to a user of the PWD through a user interface of the PWD. The parking event may be presented in text form or via a map. Additionally, the parking event can be presented audibly employing a speaker (or beeper) of the PWD. In some embodiments, the parking event may be presented by employing a calendar associated with the PWD. After presenting, the method for providing a location of a parked vehicle ends in a step 240.

Although the present invention has been described in detail, those skilled in the art should understand that they could make various changes, substitutions and alterations herein without departing from the spirit and scope of the invention in its broadest form.

What is claimed is:

1. A location system for locating a parked vehicle, comprising:
a parking determiner configured to automatically ascertain and store at least one parking event of said vehicle; and
a parking event retriever, coupled to said parking determiner, configured to present said at least one stored parking event.

2. The location system as recited in claim 1 wherein said parking determiner ascertains said at least one parking event based on entries of a positioning system.

3. The location system as recited in claim 2 wherein said entries are employed to determine a change of a motion attribute of a personal wireless device associated with said vehicle, said motion attribute selected from the list consisting of:
a direction,
an acceleration, and
a velocity.

4. The location system as recited in claim 1 wherein said parking determiner ascertains said at least one parking event based on a sensor of a personal wireless device associated with said vehicle.

5. The location system as recited in claim 4 wherein said sensor is a Radio Frequency Identification receiver.

6. The location system as recited in claim 1 wherein said parking determiner ascertains said at least one parking event based on a disconnect signal of a personal wireless device associated with said vehicle.

7. The location system as recited in claim 1 wherein said parking event retriever is configured to present said at least one stored parking event employing a user interface of a personal wireless device associated with said vehicle.

8. The location system as recited in claim 1 wherein said parking event retriever is configured to present said at least one stored parking event employing a calendar of a personal wireless device associated with said vehicle.

9. The location system as recited in claim 1 wherein said parking determiner is configured to adaptively ascertain said at least one parking event.

10. A method for providing a location of a parked vehicle, comprising:
automatically ascertaining at least one parking event of said vehicle;
automatically storing said at least one parking event; and
presenting said at least one stored parking event.

11. The method as recited in claim 10 wherein said automatically ascertaining said at least one parking event is based on entries of a positioning system.

12. The method as recited in claim 11 further comprising employing said entries to determine a change in a motion attribute of a personal wireless device associated with said vehicle, said motion attribute selected from the list consisting of:
a direction,
an acceleration, and
a velocity.

13. The method as recited in claim 10 wherein said automatically ascertaining is based on a sensor of a personal wireless device associated with said vehicle.

14. The method as recited in claim 13 wherein said sensor is a Radio Frequency Identification receiver.

15. The method as recited in claim 10 wherein said automatically ascertaining is based on a disconnect signal of a personal wireless device associated with said vehicle.

16. The method as recited in claim 10 wherein said presenting includes employing a user interface of a personal wireless device associated with said vehicle.

17. The method as recited in claim 10 wherein said presenting includes employing a calendar of a personal wireless device associated with said vehicle.

18. The method as recited in claim 10 wherein said automatically ascertaining includes adaptively ascertaining.

19. A personal wireless device, comprising:
a positioning system,
a user interface,
a parked vehicle location system coupled to said user interface and said positioning system, including:
a parking determiner configured to automatically ascertain and store at least one parking event of a vehicle associated with said personal wireless device; and
a parking event retriever, coupled to said parking determiner, configured to present said at least one stored parking event.

20. The personal wireless device as recited in claim 19 wherein said parking determiner ascertains said at least one parking event based on entries of said positioning system.

21. The personal wireless device as recited in claim 20 wherein said entries are employed to determine changes in a motion attribute of said personal wireless device, said motion attribute selected from the list consisting of:
a direction,
an acceleration, and
a velocity.

22. The personal wireless device as recited in claim 19 wherein said parking determiner ascertains said at least one parking event based on a sensor of said personal wireless device.

23. The personal wireless device as recited in claim 22 wherein said sensor is a Radio Frequency Identification receiver.

24. The personal wireless device as recited in claim 19 wherein said parking determiner ascertains said at least one parking event based on a disconnect signal of said personal wireless device.

25. The personal wireless device as recited in claim 19 wherein said parking event retriever is configured to present said at least one stored parking event employing said user interface.

26. The personal wireless device as recited in claim 19 wherein said parking event retriever is configured to present said at least one stored parking event employing a calendar associated with said personal wireless device.

27. The personal wireless device as recited in claim 19 further configured to send said at least one parking event to an other device configured to present said at least one parking event.

28. The personal wireless device as recited in claim 19 wherein said parking determiner is configured to adaptively ascertain.
